(19) United States
(12) Patent Application Publication
(10) Pub. No.: US 2025/0309528 A1
(43) Pub. Date: Oct. 2, 2025

(54) ANTENNA, ANTENNA ASSEMBLY, AND BASE STATION

(71) Applicant: HUAWEI TECHNOLOGIES CO., LTD., Shenzhen (CN)

(72) Inventors: Jinsong LV, Shanghai (CN); Tao PU, Shanghai (CN); Weihong XIAO, Dongguan (CN); Jia LV, Shanghai (CN); Zhiqiang LIAO, Shenzhen (CN)

(21) Appl. No.: 19/237,318

(22) Filed: Jun. 13, 2025

Related U.S. Application Data
(63) Continuation of application No. PCT/CN2023/136912, filed on Dec. 6, 2023.

(30) Foreign Application Priority Data
Dec. 14, 2022 (CN) 202211610512.0

(51) Int. Cl. H01Q 1/42; H01Q 1/24; H01Q 19/10; H01Q 21/06

(52) U.S. Cl. CPC H01Q 1/42; H01Q 1/246; H01Q 19/10; H01Q 21/06

(57) ABSTRACT

An antenna, an antenna assembly, and a base station includes a radome, a first antenna portion, and a second antenna portion. The first antenna portion is disposed inside the radome, and the second antenna portion is coupled to the first antenna portion, disposed outside the radome, and exposed to a surrounding environment. In this way, the radome does not need to cover the entire antenna, but covers only a portion of the antenna. Therefore, a wind load acting on a support structure by using the radome can be reduced. In addition, a cavity is provided to accommodate transmission lines of the antenna together, so that use of a connecting device such as a jumper can be reduced or even avoided, to reduce a transmission loss of the antenna.

### CROSS-REFERENCE TO RELATED APPLICATIONS

This application is a continuation of International Application No. PCT/CN2023/136912, filed on Dec. 6, 2023, which claims priority to Chinese Patent Application No. 202211610512.0, filed on Dec. 14, 2022. The disclosures of the aforementioned applications are hereby incorporated by reference in their entireties.

### TECHNICAL FIELD

The present disclosure mainly relates to the communication field. More specifically, the present disclosure relates to an antenna, an antenna assembly, and a base station.

### BACKGROUND

In the communication field, a base station antenna is a significant component. In actual engineering practice of a mobile communication network, parameters such as a network coverage requirement, traffic distribution, an anti-interference requirement, and network service quality should be fully considered when the base station antenna is designed. As network frequency bands increase, to implement a multi-band multi-mode and high-performance antenna in a network base station, a quantity of combination modules of the base station antenna increases, and the combination modules are of an integral structure, so that a new module needs to be developed for each new combination, leading to an increase in types of spare parts.

The base station antenna is usually mounted outdoors and is affected by various complex weather conditions. For example, wind acts on the base station antenna, and brings great wind resistance to a support structure that supports the base station antenna. In addition, transmission efficiency of the antenna is a significant characteristic. How to reduce the wind resistance of the base station antenna and improve the transmission efficiency of the antenna is a significant challenge that a designer faces.

### SUMMARY

To fully achieve high performance of an antenna, implementations of the present disclosure provide a solution relating to an antenna, an antenna assembly, and a base station.

According to a first aspect of the present disclosure, an antenna is provided. The antenna includes: a radome; a first antenna portion, disposed inside the radome; and a second antenna portion, coupled to the first antenna portion, disposed outside the radome, and exposed to a surrounding environment.

In an implementation of the present disclosure, the radome does not need to cover the entire antenna, but covers only a portion of the antenna. In this way, material consumption can be reduced, and a wind load acting on a support structure by using the radome can be further reduced.

In some implementations, the antenna further includes a cavity. The cavity includes: a first cavity portion, disposed inside the radome and configured to accommodate a first transmission line of the first antenna portion; and a second cavity portion, in communication with the first cavity portion and disposed outside the radome, where the second cavity portion is configured to accommodate a second transmission line of the second antenna portion, and the second transmission line is coupled to the first transmission line. In this way, different antenna portions of the antenna may be directly connected through the cavity, to reduce or avoid use of a connecting device, and ensure transmission efficiency.

In some implementations, the first cavity portion and the second cavity portion are integrally formed. In this way, such an integral formation manner can effectively improve transmission efficiency through cascading.

In some implementations, the first antenna portion includes a first reflection panel, the first reflection panel is disposed inside the radome, the second antenna portion includes a second reflection panel, and the second reflection panel is disposed outside the radome and is of a hollow-out structure. In this way, the wind load can be further reduced.

In some implementations, the hollow-out structure includes a plurality of transverse portions and a plurality of vertical portions intersecting with the transverse portions. In this way, overall weight of the antenna is reduced, and the wind load acting on the support structure is greatly reduced.

In some implementations, one or more first antenna elements are disposed on an operating surface of the first reflection panel, one or more second antenna elements are disposed on an operating surface of the second reflection panel, and the first antenna elements and the second antenna elements are configured to form a first array antenna. In this way, it can be ensured that a designed frequency of the antenna is met.

In some implementations, the one or more first antenna elements are directly connected to the first cavity portion, or the one or more second antenna elements are directly connected to the second cavity portion. In this way, a transmission loss can be reduced.

In some implementations, one or more third antenna elements are disposed on the operating surface of the first reflection panel, and the third antenna elements are configured to form a second array antenna. In this way, the antenna can implement transmission at different frequencies.

In some implementations, the one or more third antenna elements are directly connected to the first cavity portion. In this way, the transmission loss of the antenna can be reduced.

In some implementations, the radome includes an end cap, and the end cap is provided with a through hole for the cavity to pass through. In this way, the transmission lines of the antenna may not be interrupted, to ensure the transmission efficiency.

In some implementations, the first antenna portion is disposed above the second antenna portion, or the first antenna portion is disposed below the second antenna portion. In this way, a layout of the antenna may be adjusted based on actual design requirements, to ensure overall product applicability and flexibility.

According to a second aspect of the present disclosure, an antenna assembly is provided. The antenna assembly includes the antenna according to the first aspect of the present disclosure and a support structure. The antenna is mounted on the support structure.

According to a second aspect of the present disclosure, a base station is provided. The base station includes a base station support and the antenna assembly according to the second aspect of the present disclosure. The support structure is detachably fastened on the base station support at different angles.

These or other aspects of the present disclosure are clearer and more comprehensible in descriptions of the following (a plurality of) implementations.

### BRIEF DESCRIPTION OF DRAWINGS

With reference to the accompanying drawings and the following detailed descriptions, the foregoing and other features, advantages, and aspects of implementations of the present disclosure become clearer. In the accompanying drawings, same or similar reference numerals represent same or similar elements. The accompanying drawings are not necessarily drawn in proportion.

FIG. 1 shows an example environment in which an existing antenna is located;

FIG. 2 is a front view of an antenna according to an example implementation of the present disclosure;

FIG. 3 is a side view of the antenna shown in FIG. 2 at an angle;

FIG. 4 is a side view of the antenna shown in FIG. 2 at another angle, which shows an example of cascaded transmission lines inside the antenna;

FIG. 5 is a top view of a radome in an antenna according to an example implementation of the present disclosure;

FIG. 6 is a front view of an antenna according to another example implementation of the present disclosure;

FIG. 7 is a side view of the antenna shown in FIG. 6 at an angle; and

FIG. 8 is a front view of an antenna according to still another example implementation of the present disclosure.

### DESCRIPTION OF EMBODIMENTS

Embodiments of the present disclosure are described in more detail below with reference to the accompanying drawings. Although some embodiments of the present disclosure are shown in the accompanying drawings, it should be understood that the present disclosure can be implemented in various forms, and should not be construed as being limited to embodiments described herein, and instead, these embodiments are provided for more thorough and complete understanding of the present disclosure. It should be understood that the accompanying drawings and embodiments of the present disclosure are merely used as examples and are not intended to limit the protection scope of the present disclosure.

In the descriptions of embodiments of the present disclosure, the term “including” and similar terms thereof should be understood as non-exclusive inclusions, that is, “include but is not limited to”. The term “based on” should be understood as “at least partially based on”. The term “one embodiment” or “this embodiment” should be understood as “at least one embodiment”. The terms “first”, “second”, and the like may indicate different objects or a same object. The following may further include other explicit and implied definitions. In addition, the terms “connection”, “coupling”, “coupling connection”, and the like may indicate that related components are associated in different forms, including mechanical association, and association in an electrical manner, a magnetic manner, a thermal manner, or the like. The association includes direct association and indirect association through an intermediate component.

With reference to FIG. 1, the following describes an example environment 1′in which an existing antenna 2′ is located. As shown in FIG. 1, the antenna 2′ is mounted on a support structure 4′ via a connecting apparatus 3′, and withstands impact of wind 5′ from various directions. Such a support structure 4′ may be a pole or a tower. In addition, although the figure merely shows, for example, one direction of the wind 5′, it may be understood that, in an actual operating environment of the antenna 2′, a direction of the wind 5′ may be arbitrary. In an existing solution, the antenna 2′ includes a radome 20′ configured to accommodate various operating components of the antenna 2′. The wind 5′ is exerted on the radome 20′, so that a large wind load is generated on the support structure 4′ via the radome 20′. Especially when the direction of the wind 5′ is exactly perpendicular to a main surface of the radome 20′, the wind load is even larger. With continuous development of the antenna 2′, to improve acquisition and coverage capabilities of the antenna, an aperture size of the antenna 2′ gradually increases. However, because the aperture size of the antenna 2′ continuously increases, a wind load exerted by the wind 5′ on the antenna 2′ becomes increasingly large. Consequently, it is difficult for the support structure 4′ to withstand the wind load. This limits further improvement of antenna performance to some extent.

Therefore, an embodiment of the present disclosure provides an antenna that can effectively reduce a wind load and improve transmission performance. In comparison with an existing antenna structure, in the antenna according to this embodiment of the present disclosure, a size of a radome can be smaller, so that a wind load can be reduced, and manufacturing costs of the antenna can be reduced. In addition, a cavity is provided to accommodate transmission lines of the antenna together, so that use of a connecting device such as a jumper can be reduced or even avoided, to reduce a transmission loss of the antenna. In addition, a hollow-out structure may be further disposed to further reduce a wind load exerted on a support structure through the antenna, to ensure that the antenna is securely mounted.

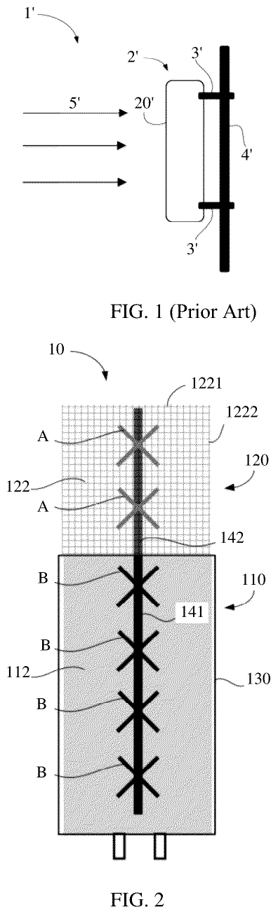

The following describes details according to embodiments of the present disclosure with reference to FIG. 2 to FIG. 8. FIG. 2 to FIG. 4 respectively show views of an antenna 10 at different angles according to some embodiments of the present disclosure. As shown in FIG. 2, the antenna 10 generally includes a first antenna portion 110 and a second antenna portion 120 that are coupled to each other. The antenna 10 further includes a radome 130. A function of the radome 130 is to protect an antenna system inside the antenna 10 from being affected by an external environment. In terms of electrical performance, the radome 130 has a good electromagnetic wave penetration characteristic. In terms of mechanical performance, the radome 130 can withstand impact of an external harsh environment, to prevent damage to an antenna structure from sunlight, precipitation, strong wind, sand and dust, or the like. With reference to FIG. 2, the first antenna portion 110 is accommodated inside the radome 130, and the second antenna portion 120 is disposed outside the radome 130 and is directly exposed to a surrounding environment. In other words, the first antenna portion 110 is provided with the radome 130, and the second antenna portion 120 is not provided with a radome. The first antenna portion 110 and the second antenna portion 120 are used in combination to integrally form an antenna array.

According to this embodiment of the present disclosure, only a portion (that is, the first antenna portion 110) of the antenna 10 is accommodated inside the radome 130, so that an area and a material of the radome 130 can be effectively reduced, to reduce overall weight of the antenna 10. Because the radome 130 is a significant component that causes a wind load, based on a design in this embodiment of the present disclosure, the wind load acting on a support structure can be greatly reduced.

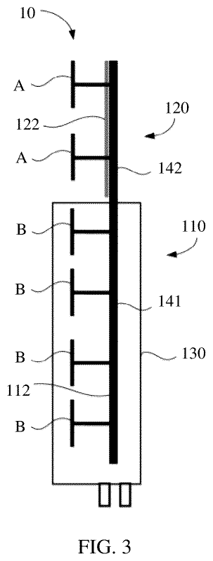

FIG. 3 is a side view of the antenna 10 shown in FIG. 2. As shown in FIG. 3, the first antenna portion 110 includes a first reflection panel 112, and the first reflection panel 112 is disposed inside the radome 130. The first reflection panel 112 is configured to improve receiving sensitivity of a signal of the antenna 10, and reflect and aggregate the signal of the antenna on a receiving point of the first reflection panel 112. In this way, receiving and transmitting capabilities of the first antenna portion 110 can be greatly enhanced, and interference caused by another electromagnetic wave from the rear to signal receiving is effectively blocked and shielded. Still with reference to FIG. 3, the second antenna portion 120 includes a second reflection panel 122, and the second reflection panel 122 is disposed outside the radome 130 and is of a hollow-out structure. A function of the second reflection panel 122 is similar to that of the first reflection panel 112.

In some embodiments, as shown in FIG. 2, the hollow-out structure includes a plurality of transverse portions 1221 and a plurality of vertical portions 1222 intersecting with the transverse portions 1221. Portions between the transverse portions 1221 and the vertical portions 1222 are hollowed out. The hollow-out structure is used for the second reflection panel 122, so that the overall weight of the antenna 10 may be reduced, and when the wind passes through the second reflection panel 122, the wind may pass through holes between the transverse portions 1221 and the vertical portions 1222, to greatly reduce the wind load acting on the support structure.

In the embodiment shown in FIG. 2, the transverse portions 1221 may be parallel to each other, and the vertical portions 1222 may also be parallel to each other. Certainly, this is merely an example. In some other embodiments, there may be a specific degree of non-parallelism between the transverse portions 1221, and there may also be a specific degree of non-parallelism between the vertical portions 1222. In the embodiment shown in FIG. 2, the transverse portions 1221 and the vertical portions 1222 may be perpendicular to each other. In some other embodiments, there may be another angle between the transverse portions 1221 and the vertical portions 1222.

In some embodiments, as shown in FIG. 2 and FIG. 3, one or more first antenna elements B are disposed on an operating surface of the first reflection panel 112 of the first antenna portion 110, and one or more second antenna elements A are disposed on an operating surface of the second reflection panel 122 of the second antenna portion 120. These antenna elements are units that form a basic structure of an antenna array, and are configured to effectively radiate or receive a radio wave based on a configured frequency band and a quantity of transmit and receive channels. In some embodiments, the first antenna elements B and the second antenna elements A may be configured to form a first array antenna, and the first array antenna may have a specific frequency. Sizes of the first antenna element B and the second antenna element A may be inversely proportional to radio frequencies of the first antenna element B and the second antenna element A. FIG. 2 and FIG. 3 show an example of specific quantities and sizes of the first antenna elements B and the second antenna elements A. It may be understood that this is merely an example, and the sizes and the quantities of the first antenna elements B and the second antenna elements A may be adjusted based on different design requirements of radio frequencies.

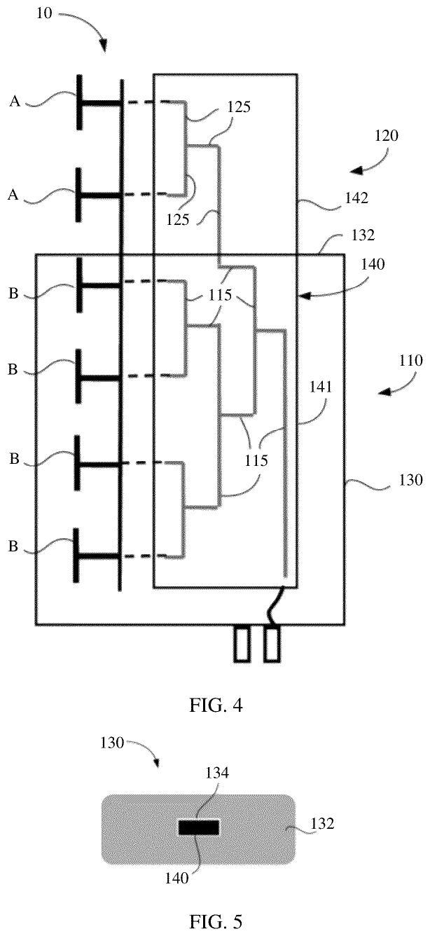

As shown in FIG. 4, the antenna 10 may further include a cavity 140. The cavity 140 generally includes a first cavity portion 141 and a second cavity portion 142 that are in communication with each other. The first cavity portion 141 is disposed inside the radome 130, and may be configured to accommodate one or more first transmission lines 115 of the first antenna portion 110. The second cavity portion 142 is disposed outside the radome 130, and may be configured to accommodate one or more second transmission lines 125 of the second antenna portion 120. In this way, the second transmission lines 125 can be directly coupled to the first transmission lines 115. The cavity 140 is disposed, so that the transmission lines of the antenna elements can be cascaded. Compared with a conventional manner, in the antenna 10 according to this embodiment of the present disclosure, use of a jumper for connection may be avoided, so that costs of an electrical material can be reduced, a transmission loss can be reduced, and transmission efficiency can be improved. In some embodiments, the cavity 140 may be in a form of a rod. In this way, the transmission lines can be accommodated, and this design can reduce a windward area due to a small volume of the rod, to further reduce wind resistance generated by the antenna 10. In some other embodiments, in addition to the first transmission lines 115 and the second transmission lines 125, the cavity 140 may further accommodate a component, for example, a phase shifter.

In some embodiments, the first antenna element B and the second antenna element A may be electrically connected to the first cavity portion 141 and the second cavity portion 142 of the cavity 140, respectively. In some embodiments, the first reflection panel 112 and the cavity 140 may be directly and electrically connected. In a further embodiment, the first reflection panel 112 and the cavity 140 may be integrated and directly connected. In some embodiments, the second reflection panel 122 may not be in direct contact with the cavity 140.

In some embodiments, the first cavity portion 141 and the second cavity portion 142 of the cavity 140 may be integrally formed. In this way, because the cavity 140 is integrated, the first transmission lines 115 of the first antenna portion 110 and the second transmission lines 125 of the second antenna portion 120 may be directly coupled without using a connector. In this way, upper and lower antenna elements of the antenna 10 may implement cascading of the transmission lines through the same cavity 140, to form an array antenna. Such an integral formation manner can effectively improve transmission efficiency through cascading.

FIG. 5 is a top view of a radome 130 in an antenna 10 according to some embodiments of the present disclosure. As shown in FIG. 5, the radome 130 may include an end cap 132, and a through hole 134 is provided in the end cap 132 for the cavity 140 to pass through. With reference to FIG. 4, the end cap 132 herein is an upper end cap of the radome 130. In this way, the first transmission lines 115 of the first antenna portion 110 and the second transmission lines 125 of the second antenna portion 120 may pass through the end cap 132 of the radome 130 through the cavity 140 to implement signal cascading of the transmission lines. Therefore, although the radome 130 accommodates only a portion (that is, the first antenna portion 110) of the antenna 10, connections between the first transmission lines 115 of the first antenna portion 110 and the second transmission lines 125 of the second antenna portion 120 are not affected. In some embodiments, a sealing strip may be further disposed between the through hole 134 and the cavity 140, to prevent moisture from passing through and damaging a component inside the radome 130.

In some embodiments, the first antenna element B may be directly connected to the first cavity portion 141 of the cavity 140. In a further embodiment, the first antenna element B may be directly and electrically connected to the first transmission lines 115 accommodated in the first cavity portion 141. In some other embodiments, the second antenna element A may be directly connected to the second cavity portion 142 of the cavity 140. In a further embodiment, the second antenna element A may be directly and electrically connected to the second transmission lines 125 accommodated in the second cavity portion 142. In this way, optimal transmission efficiency can be achieved, and an optimal protection effect without a radome can be achieved through cavity feeding.

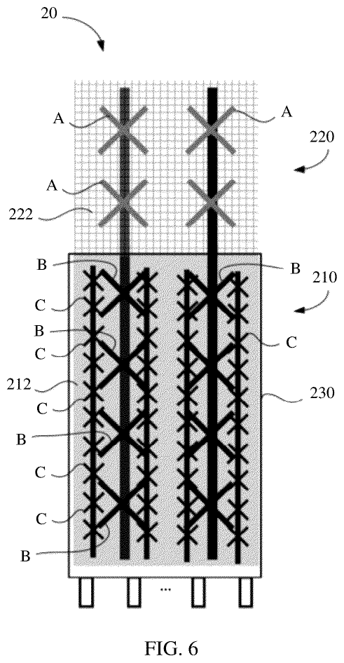

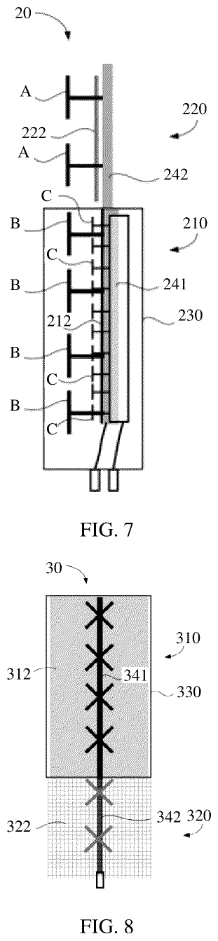

The following describes example implementations of an antenna 20 according to some other embodiments of the present disclosure with reference to FIG. 6 and FIG. 7. Different from the embodiments in FIG. 2 to FIG. 4, embodiments shown in FIG. 6 and FIG. 7 include a plurality of types of radiating units. For brevity, same parts in the two embodiments are not described in detail again.

As shown in FIG. 6, the antenna 20 generally includes a first antenna portion 210 accommodated inside a radome 230 and a second antenna portion 220 (including a second reflection panel 222) disposed outside the radome 230. The first antenna portion 210 and the second antenna portion 220 are coupled to each other. One or more third antenna elements C are disposed on an operating surface of a first reflection panel 212 of the first antenna portion 210, and the third antenna elements C are configured to form a second array antenna. The second array antenna may have a specific frequency. A size of the third antenna element C may be in inversely proportional to a radio frequency of the third antenna element C. FIG. 6 shows an example of a specific quantity and size of third antenna elements C. It may be understood that this is merely an example, and the size and the quantity of the third antenna elements C may be adjusted based on different design requirements of radio frequencies. In the illustrated embodiment, the third antenna element C is accommodated inside the radome 230.

In some embodiments, a frequency band of the second array antenna formed by the third antenna elements C may be the same as a frequency band of the first array antenna formed by the first antenna elements B and the second antenna elements A. In some other embodiments, a frequency band of the second array antenna formed by the third antenna elements C may be different from a frequency band of the first array antenna formed by the first antenna elements B and the second antenna elements A.

As shown in FIG. 7, the antenna 20 may further include a cavity. Similar to the embodiments shown in FIG. 2 to FIG. 4, the cavity includes a first cavity portion 241 and a second cavity portion 242 that are in communication with each other. The first cavity portion 241 is disposed inside the radome 230, and the second cavity portion 242 is disposed outside the radome 230. The first cavity portion 241 may be configured to accommodate a transmission line of the first antenna portion 210, and the second cavity portion 242 may be configured to accommodate a transmission line of the second antenna portion 220. It may be understood that each array antenna includes a corresponding cavity.

In some embodiments, the third antenna elements C may be directly connected to a corresponding cavity. In a further embodiment, the third antenna elements C may be directly and electrically connected to a transmission line 115 accommodated in the corresponding cavity. In this way, optimal transmission efficiency can be achieved, and an optimal protection effect without a radome can be achieved through cavity feeding.

FIG. 6 shows an example of two antenna groups formed by the first array antenna (including the first antenna elements B and the second antenna elements A) and the second array antenna (including the third antenna elements C), but this is merely an example. A person skilled in the art may know that, based on an actual use scenario, another quantity of antenna groups may be designed to meet different requirements, and such an embodiment also falls within the protection scope of the present disclosure.

FIG. 8 shows an example implementation of an antenna 30 according to still some embodiments of the present disclosure. Different from the antenna 10 in FIG. 2, the antenna 30 in FIG. 8 is of an inverted structure. In other words, a first antenna portion 310 is located above a second antenna portion 320. As shown in FIG. 8, a radome 330 is located on an upper portion of the antenna 30, the first antenna portion 310 is accommodated inside the radome 330, and the second antenna portion 320 is disposed outside the radome 330 and is directly exposed to a surrounding environment. A first reflection panel 312 of the first antenna portion 310 is disposed inside the radome 330, and a second reflection panel 322 of the second antenna portion 320 is disposed outside the radome 330 and is of a hollow-out structure. As shown in FIG. 8, the antenna 30 also has a cavity, and the cavity generally includes a first cavity portion 341 and a second cavity portion 342 that are in communication with each other. This is similar to the embodiment shown in FIG. 2, and details are not described herein again.

In the embodiment shown in FIG. 8, a through hole for the cavity to pass through may be provided on a lower end cap of the radome 330. In this case, an upper end cap of the radome 330 may not be provided with a through hole.

According to another aspect of the present disclosure, an antenna assembly is provided. The antenna assembly includes the antenna described above and a support structure. The support structure may be various types of support structures, for example, a pole or a tower. The antenna is mounted on the support structure, and may be mounted at various angles relative to the support structure.

According to still another aspect of the present disclosure, a base station is further provided. The base station includes a base station support and the antenna assembly described above. The support structure of the antenna assembly may be detachably fastened on the base station support at various appropriate angles. The base station may adapt to antennas configured for different frequency bands and different radio frequency dimensions through antennas in the antenna assembly, so that there is no need to replace a large quantity of entire antennas. In addition, this can be implemented by using a single support structure, to reduce a requirement for a site support structure, save base station space, and lower maintenance costs.

In comparison with a conventional solution, in embodiments of the present disclosure, a part of reflection panels of an antenna are accommodated in a radome, and the other part is of a hollow-out structure without a radome, so that wind resistance acting on a support structure can be greatly reduced, or the antenna can be designed with a larger surface when a same wind load is maintained, to improve antenna performance. In addition, a cavity in the antenna can accommodate transmission lines, to ensure that the transmission lines in the antenna are cascaded to improve transmission efficiency. The antenna in embodiments of this disclosure may be used as a base station antenna. It should be understood that although embodiments of the present disclosure are described by using the base station antenna as an example, this is merely an example. The antenna in embodiments of this disclosure may alternatively be an antenna for another purpose. This is not particularly limited in embodiments of the present disclosure.

Although the subject matter is described in a language specific to structural features and/or method logic actions, it should be understood that the subject matter defined in the appended claims is not necessarily limited to the particular features or actions described above. On the contrary, the particular features and actions described above are merely example forms for implementing the claims.

1. An antenna; comprising:
a radome;
a first antenna portion; disposed inside the radome; and
a second antenna portion; coupled to the first antenna portion, disposed outside the radome, and configured to be exposed to a surrounding environment.

2. The antenna according to claim 1, further comprising a cavity, wherein the cavity comprises:
a first cavity portion disposed inside the radome and configured to accommodate a first transmission line of the first antenna portion; and
a second cavity portion in communication with the first cavity portion and disposed outside the radome, wherein the second cavity portion is configured to accommodate a second transmission line of the second antenna portion, and the second transmission line is coupled to the first transmission line.

3. The antenna according to claim 2, wherein the first cavity portion and the second cavity portion are integrally formed.

4. The antenna according to claim 2, wherein the first antenna portion comprises a first reflection panel, the first reflection panel is disposed inside the radome, the second antenna portion comprises a second reflection panel, and the second reflection panel is disposed outside the radome and is of a hollow-out structure.

5. The antenna according to claim 4, wherein the hollow-out structure comprises a plurality of transverse portions and a plurality of vertical portions intersecting with the transverse portions.

6. The antenna according to claim 4, further comprising one or more first antenna elements and one or more second antenna elements, wherein the one or more first antenna elements are disposed on an operating surface of the first reflection panel, the one or more second antenna elements are disposed on an operating surface of the second reflection panel, and the one or more first antenna elements and the one or more second antenna elements are configured to form a first array antenna.

7. The antenna according to claim 6, wherein the one or more first antenna elements are directly connected to the first cavity portion, or the one or more second antenna elements are directly connected to the second cavity portion.

8. The antenna according to claim 6, further comprising one or more third antenna elements, wherein the one or more third antenna elements are disposed on the operating surface of the first reflection panel, and the third antenna elements are configured to form a second array antenna.

9. The antenna according to claim 8, wherein the one or more third antenna elements are directly connected to the first cavity portion.

10. The antenna according to claim 2, wherein the radome comprises an end cap, and the end cap is provided with a through hole for the cavity to pass through.

11. The antenna according to claim 1, wherein the first antenna portion is disposed above the second antenna portion, or the first antenna portion is disposed below the second antenna portion.

12. An antenna assembly; comprising: an antenna and a support structure, wherein the antenna is mounted on the support structure;
wherein the antenna comprises:
a radome;
a first antenna portion; disposed inside the radome; and
a second antenna portion; coupled to the first antenna portion, disposed outside the radome, and configured to be exposed to a surrounding environment.

13. The antenna assembly according to claim 12, further comprising a cavity, wherein the cavity comprises:
a first cavity portion; disposed inside the radome and configured to accommodate a first transmission line of the first antenna portion; and
a second cavity portion; in communication with the first cavity portion and disposed outside the radome, wherein the second cavity portion is configured to accommodate a second transmission line of the second antenna portion, and the second transmission line is coupled to the first transmission line.

14. The antenna assembly according to claim 13, wherein the first cavity portion and the second cavity portion are integrally formed.

15. The antenna assembly according to claim 13, wherein the first antenna portion comprises a first reflection panel, the first reflection panel is disposed inside the radome, the second antenna portion comprises a second reflection panel, and the second reflection panel is disposed outside the radome and is of a hollow-out structure.

16. The antenna assembly according to claim 15, wherein the hollow-out structure comprises a plurality of transverse portions and a plurality of vertical portions intersecting with the transverse portions.

17. The antenna assembly according to claim 15, wherein the antenna comprises one or more first antenna elements and one or more second antenna elements, and wherein the one or more first antenna elements are disposed on an operating surface of the first reflection panel, the one or more second antenna elements are disposed on an operating surface of the second reflection panel, and the one or more first antenna elements and the one or more second antenna elements are configured to form a first array antenna.

18. The antenna assembly according to claim 17, wherein the one or more first antenna elements are directly connected to the first cavity portion, or the one or more second antenna elements are directly connected to the second cavity portion.

19. The antenna assembly according to claim 17, wherein the antenna comprises one or more third elements, and wherein the one or more third antenna elements are disposed on the operating surface of the first reflection panel, and the third antenna elements are configured to form a second array antenna.

20. The antenna assembly according to claim 19, wherein the one or more third antenna elements are directly connected to the first cavity portion.
